(19) United States
(12) Patent Application Publication
(10) Pub. No.: US 2019/0333466 A1
(43) Pub. Date: Oct. 31, 2019

(54) GAMMA COMPENSATION CIRCUIT AND DISPLAY DEVICE

(71) Applicant: SHENZHEN CHINA STAR OPTOELECTRONICS TECHNOLOGY CO., LTD., Shenzhen (CN)

(72) Inventors: Juan ZHOU, Shenzhen (CN); Xianming ZHANG, Shenzhen (CN)

(21) Appl. No.: 16/247,786

(22) Filed: Jan. 15, 2019

Related U.S. Application Data
(63) Continuation of application No. PCT/CN2018/105787, filed on Sep. 14, 2018.

(30) Foreign Application Priority Data
Apr. 25, 2018 (CN) 201810377784.8

(51) Int. Cl. G09G 3/36

(52) U.S. Cl. CPC G09G 3/3696; G09G 2320/0233; G09G 2320/0276

(57) ABSTRACT

The gamma compensation circuit includes a gamma circuit, a source driver, a TFT, a liquid crystal capacitor, a common voltage circuit, and an adjustment circuit. The gamma circuit has an output terminal connected to an input terminal of the source driver. The source driver has an output an output terminal connected to the source of the TFT. The TFT's drain is connected to a first terminal of the liquid crystal capacitor. The liquid crystal capacitor has a second terminal connected to an output terminal of the common voltage circuit. The adjustment circuit has a first terminal connected to a junction of the output terminal of the gamma circuit and the input terminal of the source driver. The adjustment circuit has a second terminal connected to another junction of the second terminal of the liquid crystal capacitor and the output terminal of the common voltage circuit.

### CROSS-REFERENCE TO RELATED APPLICATIONS

This application is a continuing application of POT Patent Application No. PCT/CN2018/105787, filed on Sep. 14, 2018, which claims priority to Chinese Patent Application No. 201810377784.8, filed on Apr. 25, 2018, both of which are hereby incorporated herein by reference in their entireties.

### FIELD OF THE INVENTION

The present invention is generally related to the field of circuit structure, and more particularly to a gamma compensation circuit and a display device.

### BACKGROUND OF THE INVENTION

In the circuit of a liquid crystal display (LCD) device adopting thin film transistors (TFTs) in a 3T structure, when the source driver output a row of data voltage to charge liquid crystal capacitors and storage capacitors, capacitance coupling may occur between the data voltage and the common voltage (Vcom), resulting in ripple voltage in Vcom and causing crosstalk. This leads to unstable voltage difference across the liquid crystal capacitor and compromises display quality of the LCD device.

To improve the impact of the crosstalk, a solution is to use an operation amplifier to conduct negative feedback to compensate Vcom. However, the operation amplifier is limited by its slew rate (SR) and may not timely compensate the high-frequency noises in Vcom. The crosstalk is therefore not satisfactorily resolved, and the display quality is not much improved.

### SUMMARY OF THE INVENTION

The present invention teaches a gamma compensation circuit and a display device effectively reducing the impact by the crosstalk, and enhancing the display quality of the display device.

The present invention first teaches a gamma compensation circuit, including a gamma circuit, a source driver, a TFT, a liquid crystal capacitor, a common voltage circuit, and an adjustment circuit.

The gamma circuit has an output terminal connected to an input terminal of the source driver. The source driver has an output an output terminal connected to the source of the TFT. The TFT's drain is connected to a first terminal of the liquid crystal capacitor. The liquid crystal capacitor has a second terminal connected to an output terminal of the common voltage circuit. The adjustment circuit has a first terminal connected to a junction of the output terminal of the gamma circuit and the input terminal of the source driver. The adjustment circuit has a second terminal connected to another junction of the second terminal of the liquid crystal capacitor and the output terminal of the common voltage circuit. The adjustment circuit superimposes a first ripple voltage in a common voltage.

As the ripple voltage in Vcom is superimposed onto the gamma voltage output from the gamma circuit by the adjustment circuit, the resulted gamma voltage now includes the ripple voltage caused by crosstalk to Vcom. The resulted gamma voltage is then passed to the source driver. The data voltage output from the source driver also includes a component of the ripple voltage. When the data voltage is applied to a terminal of the liquid crystal capacitor, as Vcom operates at another terminal of the liquid crystal capacitor, the impact of the ripple voltage on the voltage difference across the liquid crystal capacitor would be reduced as both Vcom and the data voltage have the same component from the ripple voltage. Therefore, the voltage difference across the liquid crystal capacitor is more stable than the prior art. As the voltage difference across the liquid crystal capacitor determines a grey-level brightness, the gamma compensation circuit of the present invention may achieve uniform grey-level brightness, thereby enhancing display quality of the LCD device.

The TFT 105 has its gate connected to a scan line.

The adjustment circuit includes multiple resistors and capacitors series-connected together. Through the multiple capacitors and resistors, DC component in Vcom's feedback voltage is filtered multiple times so that the DC component is significantly reduced or even removed. As such, the DC component's impact to the gamma voltage may be considerably reduced or even removed. The adjustment circuit on one hand introduces ripple voltage into the gamma voltage and, on the other hand, lowers the impact of Vcom's DC component.

The adjustment circuit may further include a phase adjustment unit. The phase adjustment unit is for adjusting the phase of the first ripple voltage and the phase of the second ripple voltage obtained after the first ripple voltage runs through the series-connected resistors and capacitors of the adjustment circuit. Through the phase adjustment unit, the first and second ripple voltages would have consistent phases, thereby further enhancing the stability of the voltage difference across the liquid crystal capacitor, maintaining the uniformity of grey-level brightness, and improving display quality of the LCD device.

The common voltage circuit includes operation amplifier and feedback circuit.

A display device may include multiple above-described TFTs arranged in an array on a panel of the display device. The panel may be a liquid crystal display panel.

The gamma voltage is output from the output e inal of the gamma circuit. The gamma voltage is input into the source driver.

A data signal is output from the output terminal of the source driver. The data signal is for adjusting the TFT's grey-level brightness.

The output terminal of the source driver is connected to source of the TFT through a data line of the display device.

The present invention also teaches a display device including the gamma compensation circuit described above.

The present invention further teaches a terminal including the display device described above.

The present invention has the following advantages.

As the ripple voltage in Vcom is superimposed onto the gamma voltage output from the gamma circuit by the adjustment circuit, the resulted gamma voltage now includes the ripple voltage caused by crosstalk to Vcom. The resulted gamma voltage is then passed to the source driver. The data voltage output from the source driver also includes a component of the ripple voltage. When the data voltage is applied to a terminal of the liquid crystal capacitor, as Vcom operates at another terminal of the liquid crystal capacitor, the impact of the ripple voltage on the voltage difference across the liquid crystal capacitor would be reduced as both Vcom and the data voltage have the same component from the ripple voltage. Therefore, the voltage difference across the liquid crystal capacitor is more stable than the prior art. As the voltage difference across the liquid crystal capacitor determines a grey-level brightness, the gamma compensation circuit of the present invention may achieve uniform grey-level brightness, thereby enhancing display quality of the LCD device.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural schematic diagram showing a gamma compensation circuit according to the present invention.

FIG. 2 is a circuit diagram showing the connection between a TFT and a liquid crystal capacitor in the gamma compensation circuit of FIG. 1.

FIG. 3 is a circuit diagram showing an adjustment circuit in the gamma compensation circuit of FIG. 1.

FIG. 4 is a waveform diagram showing a second ripple voltage superimposed on a data voltage in the present invention.

FIG. 5 is a waveform diagram showing the phase difference between a data voltage and Vcom voltage in the present invention.

FIG. 6 is a structural schematic diagram showing a display device according to the present invention.

FIG. 7 is a structural schematic diagram showing a terminal according to the present invention.

### DETAILED DESCRIPTION OF PREFERRED EMBODIMENTS

The following descriptions for the respective embodiments are specific embodiments capable of being implemented for illustrations of the present invention with referring to appended figures. These embodiments are a portion of all possible embodiments of the present invention. Those of ordinary skill in this field can obtain other embodiments without innovative efforts, and these embodiments should be considered still covered the scope of the present invention.

It should be noted that terms used in the following description are for describing specific embodiments, and they are not intended to limit the present invention. It should also be noted that singular terms such as “a” “the,” in the following description and the claims should also plural conditions, Unless the context clearly indicates otherwise, terms like “and,” “or,” should also include other or all possible combinations of the referred elements.

It should also be noted that, throughout the following description, same or similar reference numbers are applied to same or similar elements.

It should also be noted that, in the following description, reference numbers may be repeated in different embodiments for clarification and simplification sakes. They should not be interpreted that there is a certain relationship between the embodiments.

It should be noted that that terms “connect,” “connected,” should be interpreted broadly. They may refer to mechanical or electrical connection. They may refer to internal connection, direct connection, or indirect connection through some intermediate element. For those skilled in the related art should be able to understand the correct meaning of these terms.

To better understand the present invention, the existing solution in the prior art is briefly reviewed as follows. An existing gamma voltage compensation circuit may include power voltage VADD, common voltage Vcom, operation amplifier, output voltage Vcomout, and feedback voltage. Vcom is converted from VADD. Vcom is passed through the operational amplifier and superimposed onto the feedback voltage to obtain Vcomout. Vcomout is applied to the TFT as reference voltage. When influenced by crosstalk, Vcomout is adjusted through negative feedback so as to reduce the impact of crosstalk. However, the operation amplifier is limited by its slew rate (SR) and may not timely compensate the high-frequency noises in Vcom. The crosstalk is therefore not satisfactorily resolved, and the display quality is not much improved.

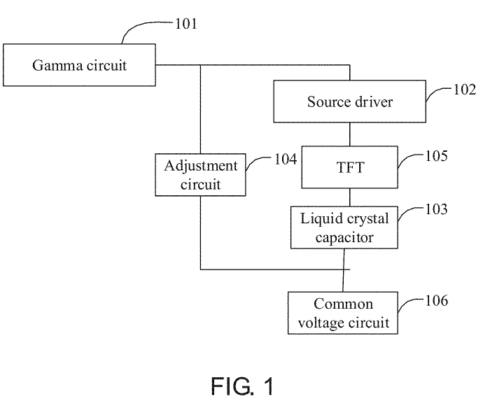

As shown in FIG. 1, a gamma compensation circuit includes a gamma circuit 101, a source driver 102, a TFT 105, a liquid crystal capacitor 103, a common voltage circuit 106, and an adjustment circuit 104.

The gamma circuit 101 has an output terminal connected to an input terminal of the source driver 102. The source driver 102 has an output terminal connected to the source of the TFT 105. The TFT 105's drain is connected to a first terminal of the liquid crystal capacitor 103. The liquid crystal capacitor 103 has a second terminal connected to an output terminal of the common voltage circuit 106. The adjustment circuit 104 has a first terminal connected to a junction of the output terminal of the gamma circuit 101 and the input terminal of the source driver 102. The adjustment circuit 104 has a second terminal connected to another junction of the second terminal of the liquid crystal capacitor 103 and the output terminal of the common voltage circuit 106. The adjustment circuit 104 is for superimposing a first ripple voltage in a common voltage output from the common voltage circuit 106 onto a gamma voltage output from the output terminal of the gamma circuit 101.

As the ripple voltage in Vcom is superimposed onto the gamma voltage output from the gamma circuit by the adjustment circuit, the resulted gamma voltage now includes the ripple voltage caused by crosstalk to Vcom. The resulted gamma voltage is then passed to the source driver. The data voltage output from the source driver also includes a component of the ripple voltage. When the data voltage is applied to a terminal of the liquid crystal capacitor, as Vcom operates at another terminal of the liquid crystal capacitor, the impact of the ripple voltage on the voltage difference across the liquid crystal capacitor would be reduced as both Vcom and the data voltage have the same component from the ripple voltage. Therefore, the voltage difference across the liquid crystal capacitor is more stable than the prior art. As the voltage difference across the liquid crystal capacitor determines a grey-level brightness, the gamma compensation circuit of the present invention may achieve uniform grey-level brightness, thereby enhancing display quality of the LCD device.

Selectively, the TFT 105 has its gate connected to a scan line.

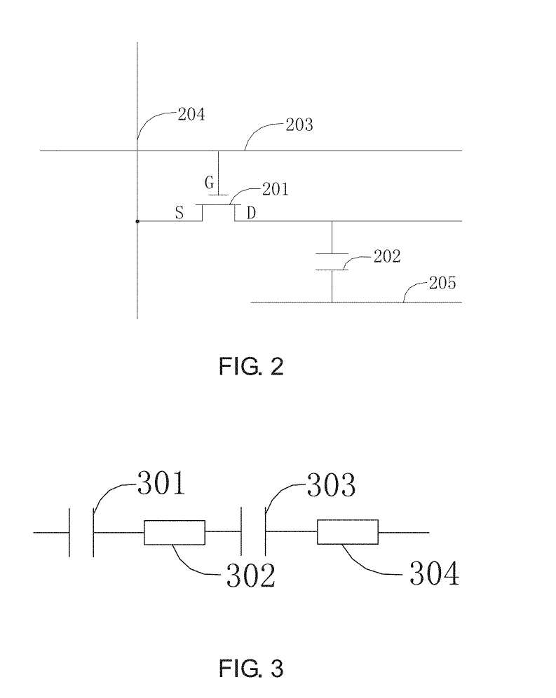

FIG. 2 shows an embodiment of the connection between the TFT and the liquid crystal capacitor in the gamma compensation circuit of FIG. 1. As illustrated, the TFT 201 has its source (S) connected to the output terminal 204 of the source driver, its gate (G) connected to the scan line 203, and its drain (D) connected to the first terminal of the liquid crystal capacitor 202. The liquid crystal capacitor 202 has the second terminal connected to Vcom 205. Please note that the scan line 203 and Vcom 205 are simplified as single lines in the drawing. When the scan line 203 provides a scan signal, the TFT 201 is turned on. A data signal is supplied by the source driver through a data line. The Vcom 205 has a constant voltage. The brightness adjustment to the TFT is achieved through the data signal.

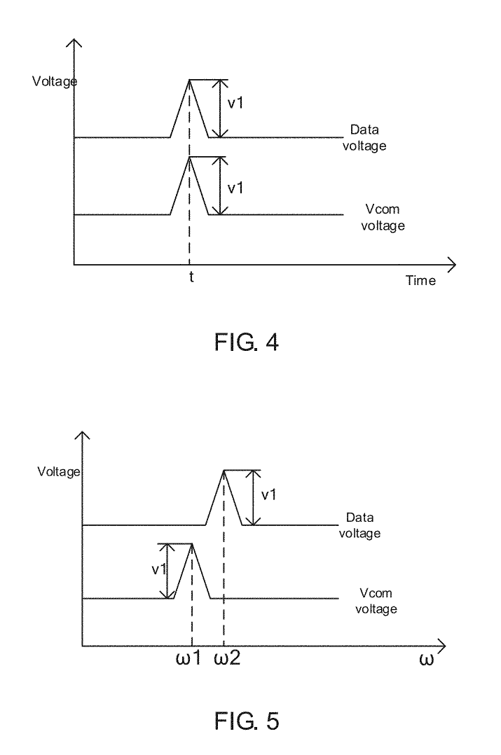

As shown in FIG. 3, the adjustment circuit includes a first capacitor 301, a second capacitor 303, a first resistor 302, and a second resistor 304. The first capacitor 301 has a first terminal connected a first terminal of the first resistor 302. The first resistor 302 has a second terminal connected to a first terminal of the second capacitor 303. The second capacitor 303 has a second terminal connected to a first terminal of the second resistor 304. By configuring two capacitors, DC component in Vcom's feedback voltage is filtered twice so that the DC component is significantly reduced or even removed and a pure second ripple voltage is obtained. As such, the DC component's impact to the gamma voltage output from the gamma circuit may be considerably reduced or even removed. In other words, the adjustment circuit on one hand introduces ripple voltage into the gamma voltage and, on the other hand, lowers the impact of Vcom's DC component. FIG. 4 shows how the second ripple voltage is superimposed onto the data voltage. As illustrated, if Vcom is raised v1 due to the crosstalk resulted from capacitance coupling, the fluctuation is also superimposed onto the data voltage and the data voltage also rises for v1. The voltage difference across the liquid crystal capacitor therefore remains stable, thereby achieving uniform grey-level brightness.

The adjustment circuit may further include a phase adjustment unit. The phase adjustment unit is for adjusting the phase of the first ripple voltage and the phase of the second ripple voltage obtained after the first ripple voltage runs through the series-connected resistors and capacitors of the adjustment circuit. Through the phase adjustment unit, the first and second ripple voltages would have consistent phases, thereby further enhancing the stability of the voltage difference across the liquid crystal capacitor, maintaining the uniformity of grey-level brightness, and improving display quality of the LCD device. FIG. 5 shows the phase difference between the data voltage and Vcom. As illustrated, after the first ripple voltage runs through the series-connected resistors and capacitors of the adjustment circuit, a phase delay (ω2−ω1) is introduced into the second ripple voltage, where ω is the angular frequency. As such, the liquid crystal capacitor may have varying voltage difference at different times. It may even be possible that that a second ripple may occur when the second ripple voltage is not superimposed at appropriate times. The second ripple may severely affect grey-level brightness uniformity and display quality. Through the phase adjustment unit in the adjustment circuit, it may adjust the phase ω2 to be consistent with the phase ω1, thereby enhancing the stability of the voltage difference across the liquid crystal capacitor and the uniformity of grey-level brightness, and improving display quality of the LCD device.

The common voltage circuit includes operation amplifier and feedback circuit.

A display device may include multiple above-described TFTs arranged in an array on a panel of the display device. The panel may be a liquid crystal display panel.

The gamma voltage is output from the output e inal of the gamma circuit. The gamma voltage is input into the source driver.

A data signal is output from the output terminal of the source driver. The data signal is for adjusting the TFT's grey-level brightness.

The output terminal of the source driver is connected to source of the TFT through a data line of the display device.

The present invention also teaches a display device including the gamma compensation circuit shown in FIG. 1.

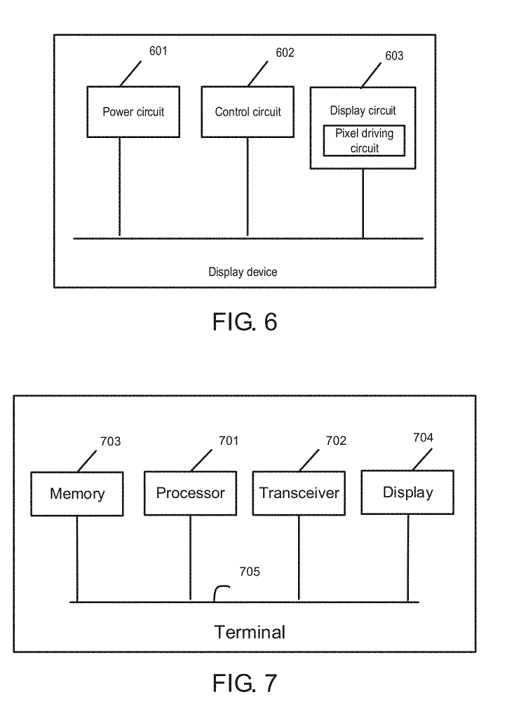

FIG. 6 is a structural schematic diagram showing the display device. As illustrated, the display device includes a power circuit 601, a control circuit 602, and a display circuit 603. The display circuit 603 includes a pixel driving circuit. The power circuit 601 converts an input voltage into appropriate voltage and current required by the display device. The control circuit 602 controls the display circuit 603 so that the pixel driving circuit may turn on and off lighting elements so as to show various texts and pictures. The display circuit 603 also includes an array of lighting elements such as LED lamps, OLED lamps, or other similar elements. The present invention does not impose specific requirement on the types of the lighting elements. It should be noted that the above description is for illustration only. In alternative embodiments, the display device may include a control circuit and a display circuit with the power circuit integrated into the control circuit.

The present invention further teaches a terminal including the above described display device.

FIG. 7 is a structural schematic diagram showing the terminal. As illustrated, the terminal includes one or more processors 701, a transceiver 702, a memory 703, a display 704, and a bus 705. The processor 701, transceiver 702, memory 703, and display 704 are connected through the bus 703 or other means. In the present embodiment, the processor 701, transceiver 702, memory 703, and display 704 are connected through the bus 703.

The processor 701 may be central processing unit (CPU), other general-purpose processor, a digital signal processor (DSP), an application specific integrated circuit (ASIC), a field-programmable gate array (FPGA), or other programmable logic device, transistor logic device, discrete hardware assembly, etc. The general-purpose processor may be a microprocessor or any other routine processor.

The memory 703 stores instruction and/or data for the processor 701. The memory 703 may include read-only memory (ROM), random access memory (RAM). A portion of the memory 703 may also be non-volatile RAM. The memory 703 may also store various messages.

The processor 701 accesses codes stored in the memory 702 through the bus 703 to perform various functions.

The display 704 displays various texts, pictures processed by the processor 701.

Above are embodiments of the present invention, which does not limit the scope of the present invention. Any equivalent amendments within the spirit and principles of the embodiment described above should be covered by the protected scope of the invention.

What is claimed is:

1. A gamma compensation circuit for a display device, comprising a gamma circuit, a source driver, a thin film transistor (TFT), a liquid crystal capacitor, a common voltage circuit, and an adjustment circuit, wherein
the gamma circuit has an output terminal connected to an input terminal of the source driver; the source driver has an output terminal connected to the source of the TFT; the TFT's drain is connected to a first terminal of the liquid crystal capacitor; the liquid crystal capacitor has a second terminal connected to an output terminal of the common voltage circuit; the adjustment circuit has a first terminal connected to a junction of the output terminal of the gamma circuit and the input terminal of the source driver; the adjustment circuit has a second terminal connected to another junction of the second terminal of the liquid crystal capacitor and the output terminal of the common voltage circuit; and the adjustment circuit converts a first ripple voltage in a common voltage output from the common voltage circuit into a second ripple voltage, and superimposes the second ripple voltage onto a gamma voltage.

2. The gamma compensation circuit according to claim 1, wherein the TFT has its gate connected to a scan line of the display device.

3. The gamma compensation circuit according to claim 1, wherein the adjustment circuit comprises a plurality of resistors and a plurality of capacitors series-connected together.

4. The gamma compensation circuit according to claim 1, wherein the adjustment circuit further comprises a phase adjustment unit for adjusting a first phase of the first ripple voltage and a second phase of the second ripple voltage so that the first and second phases are identical.

5. The gamma compensation circuit according to claim 1, wherein the common voltage circuit comprises at least an operational amplifier and a feedback circuit.

6. The gamma compensation circuit according to claim 1, wherein the display device comprises a plurality of the TFTs arranged in an array on a panel of the display device; and the panel is a liquid crystal display panel.

7. The gamma compensation circuit according to claim 6, wherein the gamma voltage is output from the output terminal of the gamma circuit; and the gamma voltage is input into the source driver.

8. The gamma compensation circuit according to claim 6, wherein a data signal is output from the output terminal of the source driver; and the data signal adjusts the TFT's grey-level brightness.

9. The gamma compensation circuit according to claim 1, wherein the output terminal of the source driver is connected to source of the TFT through a data line of the display device.

10. A display device, comprising a gamma compensation circuit as claimed in claim 1.

11. The display device according to claim 10, wherein the TFT has its gate connected to a scan line.

12. The display device according to claim 10, wherein the adjustment circuit comprises a plurality of resistors and a plurality of capacitors series-connected together.

13. The display device according to claim 12, wherein the adjustment circuit further comprises a phase adjustment unit for adjusting a first phase of the first ripple voltage and a second phase of the second ripple voltage so that the first and second phases are identical.

14. The display device according to claim 10, wherein the common voltage circuit comprises at least an operational amplifier and a feedback circuit.

15. The display device according to claim 10, wherein the display device comprises a plurality of the TFTs arranged in an array on a panel of the display device; and the panel is a liquid crystal display panel.

16. The display device according to claim 15, wherein the gamma voltage is output from the output terminal of the gamma circuit; and the gamma voltage is input into the source driver.

17. The display device according to claim 15, wherein a data signal is output from the output terminal of the source driver; and the data signal adjusts the TFT's grey-level brightness.

18. The display device according to claim 10, wherein the output terminal of the source driver is connected to source of the TFT through a data line of the display device.
